(19) United States
(12) Patent Application Publication
(10) Pub. No.: US 2012/0004977 A1
(43) Pub. Date: Jan. 5, 2012

(54) Online Customer Service Technology

(76) Inventors: Edward Peter Daniels, JR., Trumbull, CT (US); Frederic Delhalle, Saulzais-le-Potier (FR); Jonathan Eisenstein, Stamford, CT (US)

(21) Appl. No.: 13/009,159

(22) Filed: Jan. 19, 2011

Related U.S. Application Data
(60) Provisional application No. 61/360,782, filed on Jul. 1, 2010.

(51) Int. Cl. G06Q 30/00

(52) U.S. Cl. 705/14.41; 705/26.41

(57) ABSTRACT

A system and method is disclosed for providing subscription-based products to a merchant's customers which are managed by a third party provider. The merchant sells a subscription-based product to a customer and sends customer information for that customer to the provider. The provider creates a subscription program account for the customer and periodically sends instructions to the merchant for servicing the customer's account. Any instructions, such as an instruction to bill the customer for the subscription, may be branded by the merchant before being sent to the customer so that the provider is unseen by the customer. Dynamic offers for products or services may be created for a customer based on a predetermined set of factors.

### CROSS-REFERENCE TO RELATED APPLICATIONS

This patent application claims the benefit, under 35 U.S.C. §119(e), of U.S. Provisional Patent Application Ser. No. 61/360,782, filed on Jul. 1, 2010, the content of which is incorporated herein by reference.

### FIELD OF THE INVENTION

The present teachings relate to systems and methods for selling products to customers and, more particularly, to the sale of subscription-based products which are managed by third party providers.

### BACKGROUND OF THE INVENTION

Many large companies offer subscription-based products to their customers. Such products may include periodical subscriptions, products of the month, and loyalty programs, although not limited thereto. For example, Amazon LLC offers its customers a loyalty/membership program called Prime™. In exchange for paying an annual fee, Prime™ members receive benefits including favorable shipping rates.

Subscription-based programs are desirable to merchants because they provide a recurring revenue stream and engender loyalty in their customers. These programs also allow merchants to reward customers' frequent patronage with special offers and exclusive promotions. Therefore, merchants would like the opportunity to be able to offer subscription-based products to their customers.

However, subscription programs require a significant infrastructure investment and are difficult to manage. For example, merchants must invest in customer service call centers for servicing program customers. In addition, merchant billing systems are typically purchase-initiated and do not have the ability to automatically bill customers periodically for membership subscriptions. For these reasons and others, many merchants, and particularly smaller merchants, are not able to provide subscription-based products to their customers.

Therefore, it would be beneficial to have a superior system and method for offering subscription-based products and online customer service technology.

### SUMMARY OF THE INVENTION

The needs set forth herein as well as further and other needs and advantages are addressed by the present embodiments, which illustrate solutions and advantages described below.

The system of the present embodiment includes, but is not limited to, a merchant billing system, a provider processing system, and a computer processor. A subscription-based product is offered by a merchant and managed by a provider. The computer processor acts as an intermediary between the merchant billing system and the provider processing system and is adapted for communicating with the merchant billing system. The merchant billing system sends customer information for a customer to the computer processor after the merchant billing system processes the sale of the subscription-based product to the customer. The computer processor sends the customer information to the provider processing system for creation of a customer account, the provider processing system sends a billing instruction for the customer account to the computer processor, and the computer processor sends the billing instruction to the merchant billing system.

The method of the present embodiment includes the steps of, but is not limited to, selling the subscription-based product to the customer, receiving customer information from the customer, sending a subset of customer information to a computer processor, receiving instructions from the computer processor to bill the customer for the subscription-based product, billing the customer for the subscription-based product based at least in part on the received instructions, and sending the status of the customer's account to the computer processor. The computer processor acts as an intermediary between a merchant and a provider by sending customer information to the provider and receiving instructions from the provider for the merchant.

Other embodiments of the system and method are described in detail below and are also part of the present teachings.

For a better understanding of the present embodiments, together with other and further aspects thereof, reference is made to the accompanying drawings and detailed description.

### BRIEF DESCRIPTION OF THE DRAWINGS

FIG. 1 is schematic block diagram depicting one embodiment of the system according to the present teachings;

FIG. 2 is a flow chart depicting one embodiment of the method according to the system of FIG. 1;

FIG. 3 is a block diagram depicting another embodiment of the system according to FIG. 1 employing a computer processor that integrates with the merchant's billing system;

FIG. 4 is a block diagram depicting yet another embodiment of the system according to FIG. 1 employing a computer processor that integrates with the merchant's billing system and facilitates real-time communication between the merchant and the provider;

FIG. 5 is a flow chart depicting one embodiment of the method of making a dynamic offer according to the system of FIG. 1;

FIG. 6 is a flow chart depicting another embodiment of the method of making a dynamic offer according to the system of FIG. 1; and

FIG. 7 is a flow chart depicting still another embodiment of the method of making a dynamic offer according to the system of FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments.

The present teachings relate to a system and method for providing subscription-based products (e.g., customer loyalty programs, product of the month, etc.) (hereinafter referred to as “programs”) which are then outsourced to a third party (e.g., program provider, etc.) (hereinafter referred to as “provider”) for management.

In online marketing today, although not limited thereto, larger merchants offer subscriber-based membership and/or loyalty programs in order to increase retention and engagement with their customers. For smaller merchants there is no such luxury. In order to solve for this need, systems and methods are disclosed for providing integrated marketing and membership services managed by a third party provider but which is done so seamlessly in the eyes of the customer.

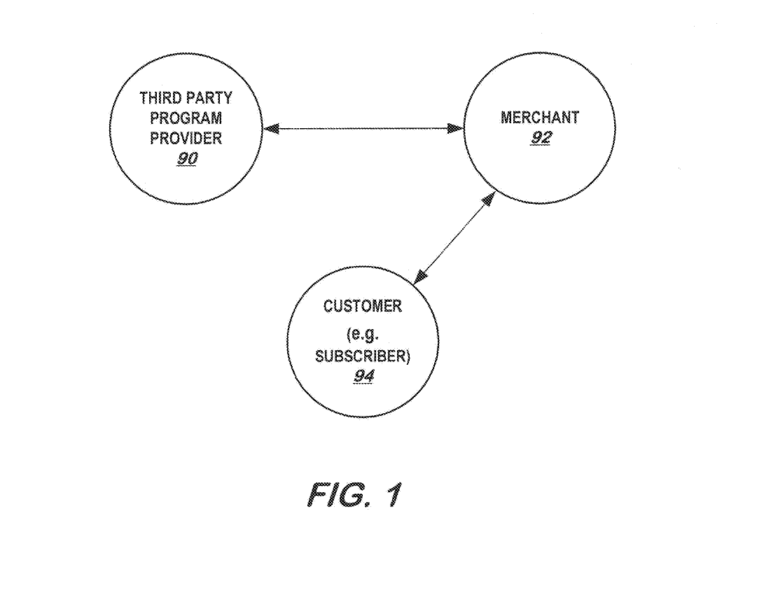

Referring now to FIG. 1, shown is schematic block diagram depicting one embodiment of the system according to the present teachings. One objective of the present teachings is to provide the ability for a merchant 92 to offer customers 94 merchant-branded subscriber programs. Preferably, the merchant 92 may bill its customers 94 directly for membership in any such programs and allow a third party program provider 90 to service program customers 94 in a secure fashion, and without having to supply the customer's private information (e.g., credit card information, etc.) to the provider 90.

A merchant 92 such as an online retailer (e.g., e-tailer), for example, although not limited thereto, may offer subscription-based products in addition to its customary products. In one embodiment, the customer 94 may shop for the subscription-based product like any other product by placing it in his or her shopping cart. When a customer 94 purchases a subscription-based product, the merchant 92 may complete the transaction as any regular purchase (e.g., price paid may be first subscription installment payment) and then may send the provider 90 the customer's information (e.g., name, address, etc.) needed to create a program account. Due to concerns over credit card fraud and customer privacy, although not limited thereto, the information sent to the provider 90 may not include any financial information.

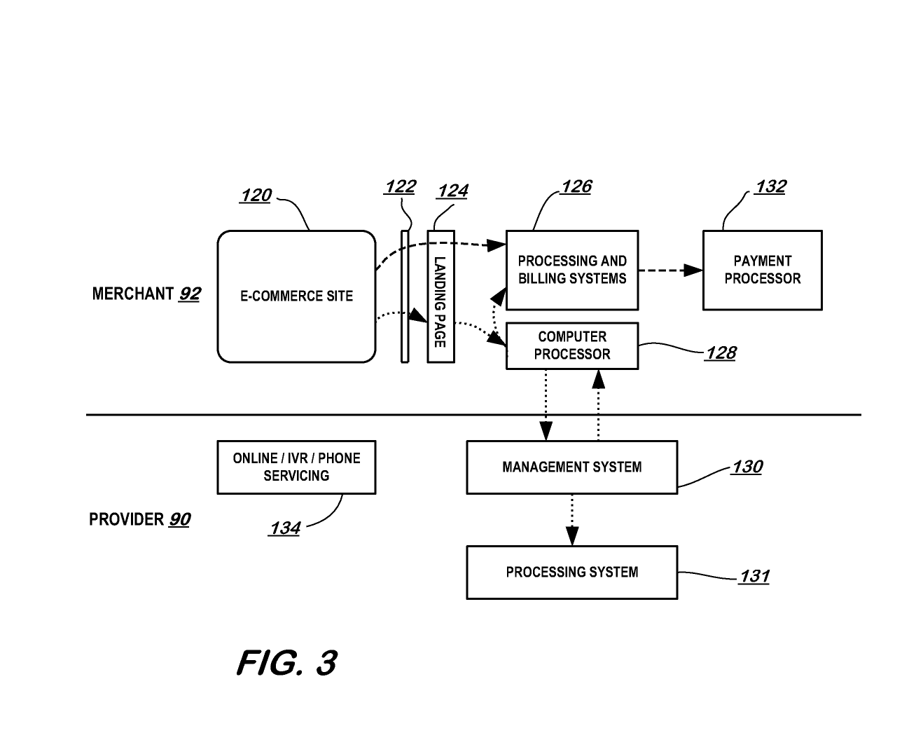

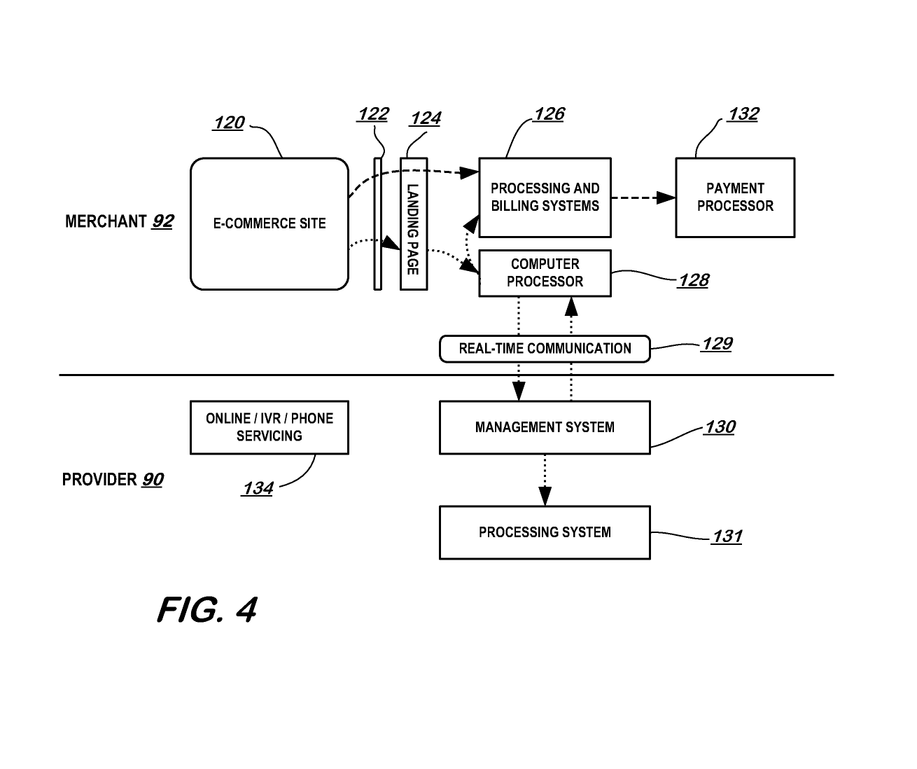

In one embodiment, discussed further below in relation to FIGS. 3 and 4, the program provider 90 may employ a computer processor executing specialized software which integrates with the merchant's payment processing/billing system, although not limited thereto. In this way, the system of the present teachings may provide “plug-and-play” interoperability with traditional merchant billing systems. The computer processor may receive customer information from the merchant's system for opening new program accounts and relay that information to the provider 90 over a network, although not limited thereto. The provider 90 may periodically send instructions for managing the customer's program account (e.g., subscription payment due, etc.) to the computer processor, which then relays the instructions to the merchant 92.

The provider 90 can manage customers' program accounts and permit the merchant 92 to directly bill the customer 94 under its own brand. This way, the provider 90 may be unknown to the customer 94. In addition, no personal financial information ever needs to be transmitted to the provider 90.

It is appreciated that the merchant 92 may be an e-tailer, a traditional retailer, or even a telemarketer who “upsells” a subscription-based product, although not limited thereto. It is further appreciated that the systems and methods described herein could be tailored for any number of potential types of merchants/salespeople (e.g., inbound magazine sales, outbound order confirmation, lead generation telemarketers, etc.) and the present teachings are not limited to these particular embodiments. However, the term “merchant” will be used throughout for the sake of simplicity.

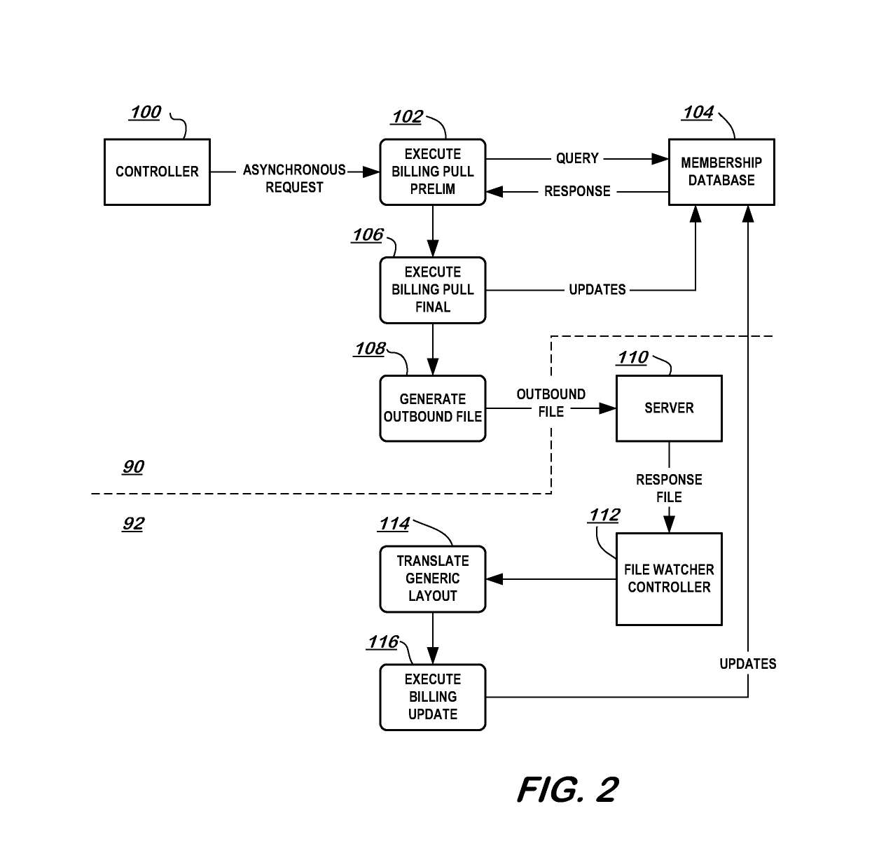

Referring now to FIG. 2, shown is a flow chart depicting one embodiment of the method according to the system of FIG. 1. In this embodiment, although not limited thereto, no particular hardware (e.g., provider computer processor) may be used to integrate with the merchant's billing system. Instead, new subscriber information may be periodically transferred to the provider 90. This may occur at regular intervals or even manually on an as-needed basis.

The provider 90 may create subscription accounts for the customers 94 listed in each transmission it receives from the merchant 92 and manage the subscriber accounts by, for example, periodically sending the merchant 92 instructions regarding billing. In addition, the provider 90 may periodically send the merchant 92 other messages intended for the customer 94. For example, based upon resolution of a customer service issue the provider 90 may instruct the merchant 92 to refund a customer's payment. Alternatively, the provider 90 may send the merchant 92 targeted advertising, special offers, or program-related information for the customer 94. When the merchant 92 receives a communication intended for the customer 94, the merchant 92 may re-brand it and forward it to the customer 94. Re-branding may include changing the layout and design of the message or simply forwarding it from the merchant's address. In this way, the existence of the provider 90 is transparent to the customer 94 and the customer 94 believes he or she is doing business with the merchant 92. The merchant 92 also maintains control over its relationship with the customer 94 by approving/controlling each communication.

As shown, the provider 90 may have a controller 100 which pulls 102, 106 billing information from the provider's membership database 104. This may include instructions to bill customers 94 for their subscriptions. It is to be appreciated that traditional merchant billing systems do not have the ability to periodically automatically bill customers 94, so the provider 90 will need to instruct the merchant 92 when to do so. The provider 90 may then generate a generic file 108 of billing instructions to send 110 to the merchant 92.

The merchant 92 may have a process for watching for files 112 sent from the provider 90. The merchant 92 may then translate 114 the generic file sent from the provider 90 in order to brand the correspondence for delivery to its customers 94. After the correspondence is sent, the merchant 92 may then send any updates 116 (e.g., customer billed, payment for customer received, etc.) to the provider 90 to update the membership database 104. In one embodiment, although not limited thereto, the merchant 92 may simply append a response for each billing transaction and return the generic file to the provider 90 so a disposition of the transaction can be recorded by the provider 90.

Referring now to FIG. 3, shown is a block diagram depicting another embodiment of the system according to FIG. 1 employing a computer processor 128 that integrates with the merchant's billing system 126. In this embodiment, the customer 94 may purchase (e.g., subscribe to) a program or some other product offered on a merchant's e-commerce site 120, although not limited thereto. Once the customer 94 completes the transaction 122, the customer 94 may be provided with a landing page 124, which may, for example, although not limited thereto, be a program home page, or some other acknowledgement of the customer's new subscription/purchase.

At the same time that the transaction 122 is completed, the merchant's e-commerce site 120 may send complete customer information (including billing information, etc.) to its merchant billing system 126 as well as a subset of the customer information to the computer processor 128 intended for the provider 90, although not limited thereto. The customer information may be bifurcated in this fashion so that the customer's private information (e.g., payment info, etc.) never needs to be disclosed to the provider 90.

The computer processor 128 may then send the customer information to the provider management system 130. There, a new customer account for the subscription program may be created. The provider 90 may manage the account and periodically send instructions back to the computer processor 128, which in turn communicates with the merchant billing system 126. This way, any billing for the customer will be billed directly by the merchant 92 and handled by its own billing system 126 and processing system 132. The computer processor 128 may be located near the merchant's billing system 126 or processing systems 132 or otherwise be under the physical control of the merchant 92 (e.g., at merchant premises, data center, etc.). This may provide it the ability to securely physically connect with the merchant's 92 systems.

In one embodiment, although not limited thereto, the computer processor 128 may accumulate and store customer information that it receives from the billing system 126 and periodically send “batches” of information to the provider management system 130. In one alternative embodiment, the provider management system 130 may periodically monitor the computer processor 128 and retrieve customer information waiting to be sent. Similarly, the merchant billing system 126 may perform the same monitoring or receive batches of instructions/correspondence stored on the computer processor 128 which are sent by the provider 90. In this way, the customer information (or a subset thereof) may be periodically transferred between the provider 90 and the merchant 92.

One objective of the computer processor 128 is to act as a “middleman” or broker between the merchant's billing/processing systems 126, 132 and the provider's management/processing systems 130, 131. The use of the computer processor 128 within the merchant's 92 environment is desirable to provide increased operability (e.g., plug-and-play communication with provider 90) and ensure the bifurcation of customer financial data from membership and demographic data, although not limited thereto. The provider 90 may be able to customize the computer processor 128 for a merchant's particular billing system 126 so that all the merchant 92 has to do is connect them together for instant interoperability. All customer information remains securely with the merchant 92, while the provider 90 may only have access to the information which it needs (and that which the merchant 92 chooses to disclose) in order to service subscribers.

Whenever the provider 90 sends customer messages to the merchant 92 (e.g., program announcements, promotions, etc.), the merchant 92 can rebrand those messages before sending them to the customer 94. The provider 90 may have service capabilities 134 to respond to any subscriber customer service needs. This may be in a number of different methods, whether by post, electronic mail, telephone, web, or any other communication medium, and the merchant 92 may direct all subscription-based product inquiries to the provider's servicing components 134. If a customer 94 has a customer service issue, they may be directed to the provider 90, who can act on the merchant's 92 behalf and under the merchant's brand.

The provider 90 may supply a customer service website, for example, which is branded with the merchant's brand and accessible from the merchant's website. Each merchant 92 may provide its customers 94 with a special customer service phone number that is directed to the provider 90 who can answer the phone and service the customers 94 using the merchant's brand. It is appreciated that the provider 90 may service an unlimited number of subscription programs for an unlimited number of merchants 92 and having particularized contact information for each subscription program may help the provider 90 to properly brand its customer service when responding to customer 94 inquiries.

It may be preferable for the provider 90 to be completely invisible to the customer 94 so that the customer 94 thinks that he or she is only dealing with the merchant 92. Yet the merchant 92 is able to offer an unlimited number of new subscription-based products by outsourcing program management to the provider 90.

Referring now to FIG. 4, shown is a block diagram depicting yet another embodiment of the system according to FIG. 1 employing a computer processor 128 that integrates with the merchant's billing system 126 and facilitates real-time communication 129 between the merchant 92 and the provider 90. This embodiment may work in substantially the same way as that described in relation to FIG. 3, however in this case information transfer between the computer processor 128 and the provider's management system 130 may occur in real-time 129.

Using the provider's computer processor 128, the merchant 92 can be assured that customer information will be communicated promptly and in an anticipated format to the provider 90. Similarly, instructions sent from the provider 90 to the merchant may be transmitted real-time by the computer processor 128. For example, although not limited thereto, when the provider 90 determines that a customer 94 needs to be billed for their subscription(s), it can automatically send the billing notification, which may include an invoice and which may then be automatically branded with the merchant's brand and sent to the customer 94. In one embodiment, although not limited thereto, the computer processor 128 may automatically brand the any correspondence received from the provider 90 before sending it to the customer 94.

It is appreciated that subscription-based product stock-keeping units (SKU) may be integrated with the merchant's 92 other products so that customers 94 may shop for these programs as any other product, by adding them to their shopping carts and checking out. Using the methods disclosed herein, the customer 94 may get directly billed by the merchant 92 for any periodic subscription fees.

The provider 90 may also offer a merchant-branded website to permit customers 94 to view their program accounts online. In one embodiment, customers 94 may access their account information through the merchant's website so that they see one seamless, integrated account view, although not limited thereto. The provider 90 may design the website which may be accessible or even hosted by the merchant 92, and may offer functionality including acquisition landing pages, product pages, and program information, although not limited thereto.

The provider 90 may also provide an interface for the merchant 92 to be able to easily add new programs or customize programs that it offers to its customers 94. It is intended that the present teachings include a full-service “membership services as a service model.” The provider 90 may not only provide consulting services for the creation of new subscription-based products, but may also have a library of programs from which the merchant 92 can choose from (and brand) to offer to its customers 94. Through a website, for example, although not limited thereto, a merchant 92 may be able to choose from among a library of subscription-based products which it may then brand and integrate into its product offering. Once a merchant 92 chooses a program, it may add the program to its inventory (e.g., program name, description, price, SKU, etc.) and when a customer 94 purchases the program the merchant 92 may communicate customer information to the provider 90 according to the present teachings.

Referring again to FIG. 1, in one embodiment, the system and method according to the present teachings may incorporate the ability to dynamically create, present and track personalized offers for products. When a customer 94 is making a purchase or at some other predetermined time, a customized offer may be presented. The offer may be designed and presented by the merchant 92 (e.g., merchant is offer provider) or by some other provider 90. Based on a customer's demographics, web behavior, credit behavior/history as well as geographical location (GEO-Fencing), although not limited thereto, it may be possible for the merchant 92 or provider 90 to anticipate the success of particular programs and targeted offers. In this way, the offerer can substantially increase the success rate (e.g., acceptance) of offers by customizing them for each customer 94.

For example, when a customer 94 views a product (which is not limited to a subscription-based product), adds the product to his or her shopping cart (e.g., Internet-based purchase or otherwise), or even upon checkout (e.g., includes bricks and mortar purchase, etc.), a dynamic offer can be created based on the customer's 94 web behavior including product(s) reviewed and/or purchased and the consumer's demographics (e.g., traditional demographics, credit rating, geo-location, etc.). This way, it is possible to identify an additional product or service that the customer 94 may be interested in purchasing. This additional product or service may be a service contract for a product the customer 94 has already purchased or a predetermined product bundle, for example, which may include subscription-based products, although not limited thereto. The dynamically created offer can be built and priced specifically for that customer 94 in order to maximize the potential for acceptance. Further, the success (e.g., was it accepted) of that offer can be tracked in order to more successfully customize offers to customers 94 with similar demographics in the future. In this way, the system learns from the history of its offers.

In one embodiment, although not limited thereto, customer 94 behavior may be tracked (e.g., which products did they view in an online store, etc.) and along with other demographic information, all available customer information may be analyzed in order to determine an appropriate offer to provide the customer 94. Based upon factors including traditional demographics (e.g., age, race, income, gender, religion, education, etc.), credit rating, tracked web behavior, geo-location (e.g., proximity to a predetermined location such as service provider or store, etc.) and others, it is possible to create a completely customized offer which maximizes the possibility of acceptance. The offer may include alternative pricing, up sells, down sells, and cross sells, among others. The offer may also be based upon real-time inventory, sales goals, and strategic marketing initiatives (e.g., building buzz, penetrating new demographics, etc.).

In an alternative embodiment, a customer 94 may enroll in a dynamic offer program and set up preferences for offers he or she is willing to consider. A customer 94 may navigate to a certain web page in order to provide demographic information and preferences, although not limited thereto. Preferences may include interests as well as preferred communication style, although not limited thereto. The preferences may then be used in the creation of a dynamic offer. The customer 94 may be tracked via global positioning system (GPS) or by their online behavior (e.g., what they shop for, which sites they visit, how long they stay, etc.), although not limited thereto. These pieces of information (e.g., geo-location, demographics, buying habit information, etc.) are analyzed in order to create a dynamic offer. The dynamic offer may then be sent to the customer 94 on their mobile device, by emailing it to them, by notifying them next time they log on to a website, or by some other method.

The predetermined set of factors used to create a dynamic offer may include information about the customer 94 obtained by searching database records not under the control of the provider 90. For example, although not limited thereto, the provider 90 may search public records, social websites, blogs, etc., to learn information about the customer 94 and dynamically create an appropriate offer. Such records may, for example, indicate a customer's likes or dislikes.

The dynamic offer can immediately be accepted, processed for billing and future reference by the customer 94, and electronically fulfilled. The system may also dynamically generate a cross sell offer based on the same criteria either at the point of sale or during a later customer 94 reference to the offer. This capability also allows for dynamically live customer 94 testing of different product components in order to identify product bundles with the highest customer 94 appeal to a particular demographic or other subset of customers 94.

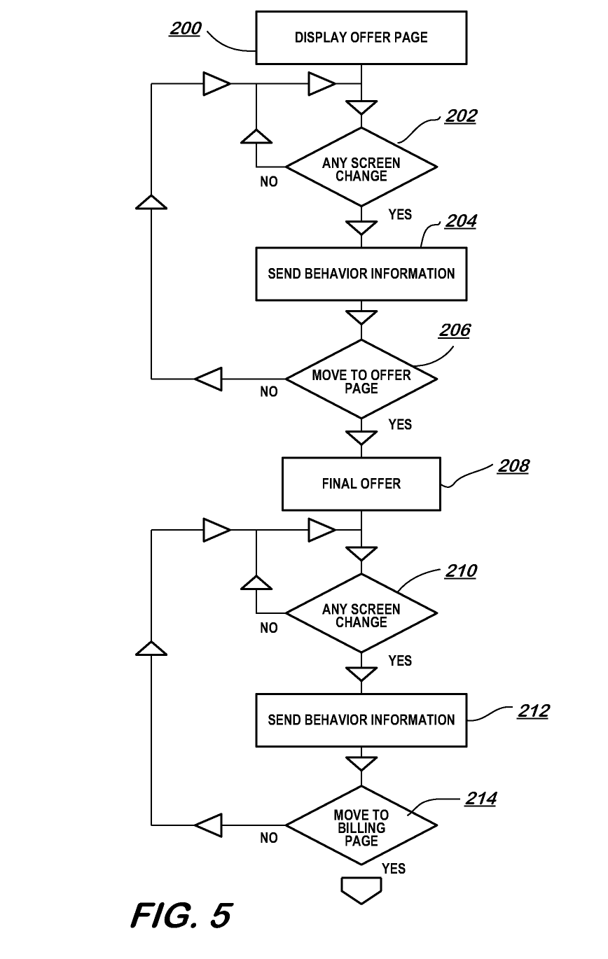

Referring now to FIG. 5, shown is a flow chart depicting one embodiment of the method of making a dynamic offer according to the system of FIG. 1. The merchant 92 may display an initial offer page 200 for a product or products which may be continually updated on a real-time basis, resulting in screen changes 202 to the customer 94. The customer's 94 web behavior and other information may be tracked and that and demographic information may be transmitted 204 to the offer provider 90 (e.g., merchant, program provider, etc.). Based at least in part on this information, the customer 94 may be directed 206 to a final offer page 208, where the price point and workflow are determined using the customer's information. Again, any screen changes 210 may modify the offer and be sent to the offer provider 212 for analysis. When the customer 94 accepts an offer he or she may be directed to the billing web page 214.

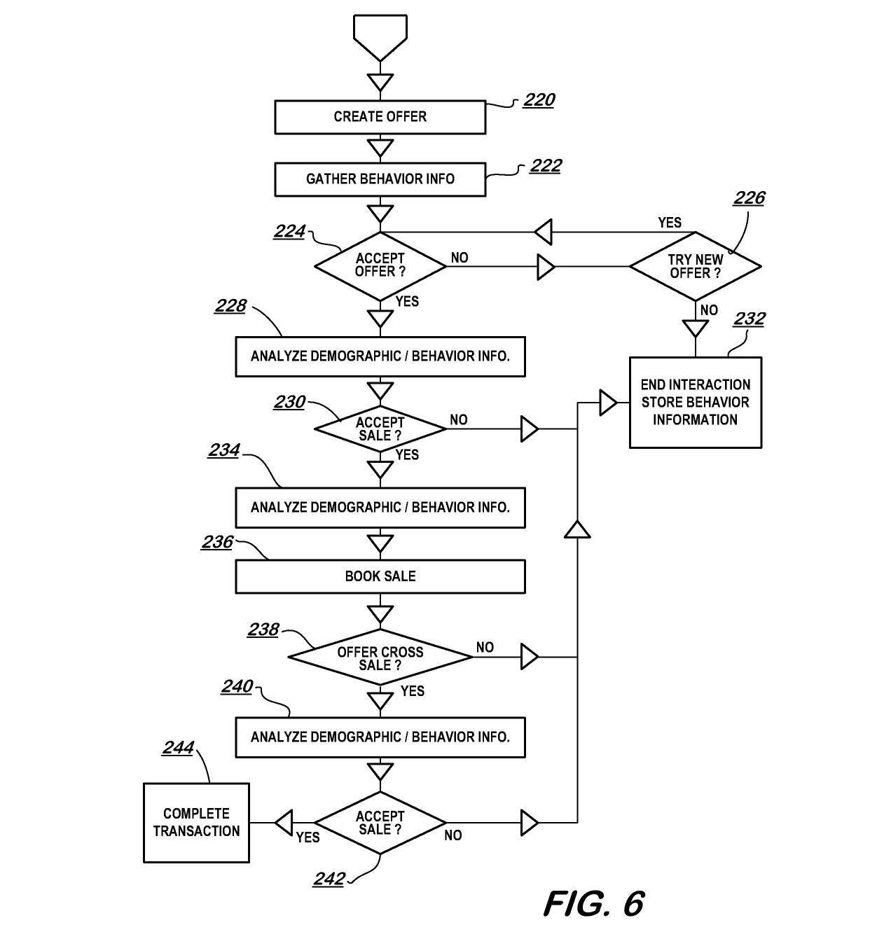

Referring now to FIG. 6, shown is a flow chart depicting another embodiment of the method of making a dynamic offer according to the system of FIG. 1. The system may monitor the customer's shopping experience and continuously analyze 228, 234, 240 the customer's shopping behavior and other information in order to create offers 220 and cross sale offers 238 for the customer 94, although not limited thereto. The offer provider may create an offer 220 and gather customer behavior and other information 222. If the customer 94 rejects the offer, a new offer may be offered 226. If the customer 94 accepts the offer 224, the offer provider 90 may analyze the customer's information 228 and determine whether to accept or reject 230 the sale. If the sale is accepted, the customer's information may be analyzed 234 and the sale booked 236. At this point, the offer provider may offer a cross sale 238. If the customer 94 accepts this, the offer provider may analyze the customer's behavior 240, accept the sale 242, and complete the transaction 244. In the alternative, the interaction with the customer 94 may be ended 232.

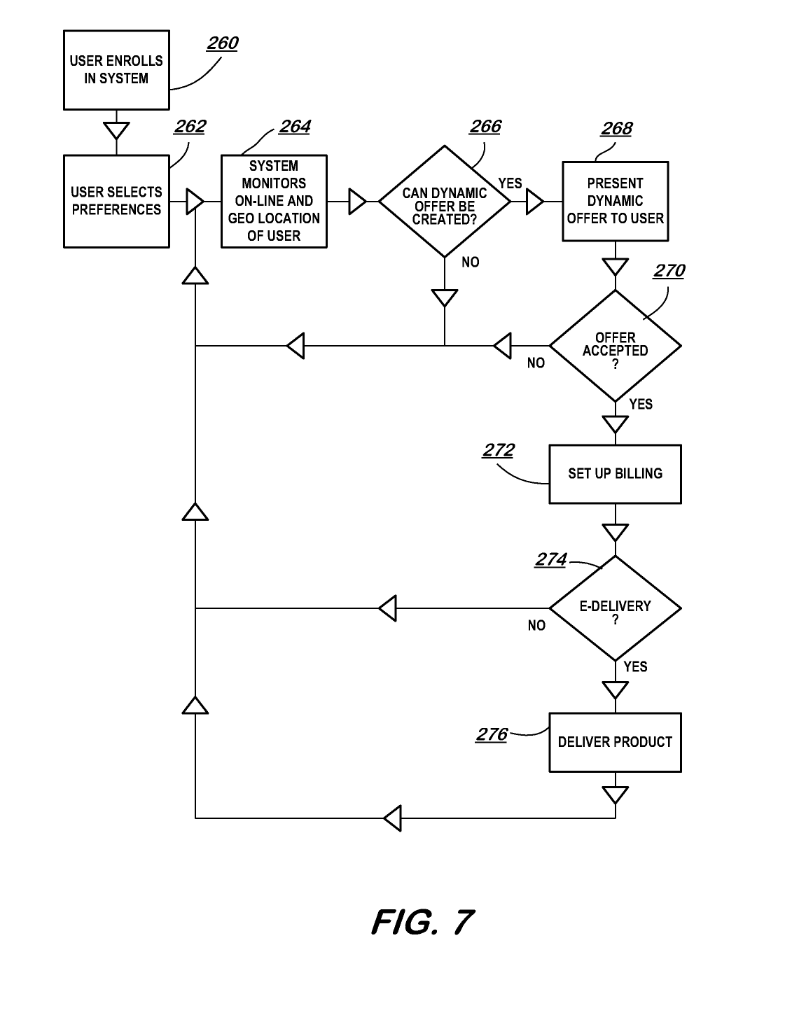

Referring now to FIG. 7, shown is a flow diagram depicting still another embodiment of the method of making a dynamic offer according to the system of FIG. 1. In this embodiment, although not limited thereto, the customer 94 may first sign up or enroll 260 in the dynamic offering program and provide demographic information and select preferences 262. Preferences may include communication styles, trigger points for offers, types of offers and other preferences, although not limited thereto. The system may then continuously monitor 264 customer behavior and information such as behavior while he or she navigates online or even physically travels (e.g., geo-location). If an appropriate dynamic offer can be created 266 based on the customer's behavior/information, the system may then present the offer 268 to the customer 94. If the customer 94 accepts the offer 270, the customer 94 may be billed 272 and the product delivered 274, which may be by electronic delivery 276, although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the disclosure and its legal equivalents, as understood by those of skill in the art relying upon the specification and the attached drawings.

What is claimed is:

1. A method for offering a subscription-based product to a customer which is managed by a provider, comprising the steps of:
selling the subscription-based product to the customer;
receiving customer information from the customer;
sending a subset of customer information to a computer processor;
receiving instructions from the computer processor to bill the customer for the subscription-based product;
billing the customer for the subscription-based product based at least in part on the received instructions; and
sending the status of the customer's account to the computer processor;
wherein the computer processor acts as an intermediary between a merchant and the provider by sending customer information to the provider and receiving instructions from the provider for the merchant.

2. The method of claim 1 wherein the selling of the subscription-based product is performed by a merchant billing system and the computer processor is adapted for communicating with the merchant billing system.

3. The method of claim 1, further comprising the step of branding the received billing instructions with the merchant's brand, wherein the step of billing the customer includes sending branded billing instructions.

4. The method of claim 1 wherein the computer processor is under the physical control of the merchant.

5. The method of claim 1 wherein the computer processor stores the subset of customer information which is periodically transferred to the provider.

6. The method of claim 1 wherein the computer processor sends the subset of customer information to the provider when it receives it.

7. The method of claim 1, further comprising the step of selecting a subscription-based product for sale by the merchant from a library of programs provided by the provider.

8. The method of claim 1, further comprising the steps of:
receiving correspondence for the customer from the computer processor;
rebranding the correspondence; and
sending the correspondence to the customer;
wherein the computer processor receives the correspondence from the provider and sends the correspondence to the merchant.

9. The method of claim 1, further comprising the step of creating a customer account after sending the subset of customer information to the computer processor, wherein the provider creates the customer account.

10. The method of claim 1 wherein the subset of customer information does not include financial information.

11. A method for facilitating the management of a subscription-based product by a provider, comprising the steps of:
providing a computer processor in communication with a merchant's billing system;
receiving, by the computer processor, customer information from the merchant's billing system after the sale of the subscription-based product to the customer;
sending, by the computer processor, the customer information to a provider computer to create a subscription account;
receiving, by the computer processor, instructions from the provider computer regarding the subscription account; and
sending, by the computer processor, the instructions to the merchant's billing system.

12. The method of claim 11 wherein the computer processor is under the physical control of the merchant.

13. The method of claim 11 wherein the computer processor stores the customer information which is periodically transferred to the provider computer.

14. The method of claim 11 wherein the computer processor sends the customer information to the provider computer when it receives it.

15. The method of claim 11 wherein the instructions are branded with the merchant's brand before the step of sending the instructions.

16. The method of claim 11 further comprising the step of sending, by the computer processor, the status of the customer's account to the provider computer.

17. A method for managing a subscription-based product by a provider, comprising the steps of:
providing a computer processor and the subscription-based product to a merchant;
receiving from the computer processor customer information for a customer who purchased the subscription-based product;
creating a subscription account for the customer; and
sending instructions to the computer processor regarding the subscription account;
wherein the computer processor acts as an intermediary between the merchant and the provider.

18. The method of claim 17 further comprising the step of sending the instructions to the customer wherein the instructions are branded with the merchant's brand.

19. The method of claim 17 wherein the computer processor is under the physical control of the merchant.

20. The method of claim 17 wherein the computer processor stores the customer information which is periodically transferred to the provider.

21. The method of claim 17 wherein the computer processor sends the customer information to the provider when it receives it.

22. The method of claim 17, further comprising the step of adapting the computer processor to communicate with a merchant billing system.

23. The method of claim 17, further comprising the steps of sending correspondence to the computer processor intended for the customer wherein the correspondence is branded with the merchant's brand before being sent to the customer.

24. The method of claim 17 further comprising the step of receiving from the computer processor the status of the customer's account.

25. A system for facilitating management by a provider processing system of a subscription-based product offered by a merchant billing system, comprising:
a computer processor;
wherein the subscription-based product is offered by a merchant and managed by a provider;
the computer processor acts as an intermediary between the merchant billing system and the provider processing system and is adapted for communicating with the merchant billing system;
the merchant billing system sends customer information for a customer to the computer processor after the merchant billing system processes the sale of the subscription-based product to the customer;
the computer processor sends the customer information to the provider processing system for creation of a customer account;
the provider processing system sends a billing instruction for the customer account to the computer processor; and
the computer processor sends the billing instruction to the merchant billing system.

26. The system of claim 25 wherein the billing instruction is branded with the merchant's brand before being sent to the customer.

27. The system of claim 26 wherein the computer processor brands the instruction.

28. The system of claim 25 wherein the computer processor is under the physical control of the merchant.

29. The system of claim 25 wherein the computer processor stores the customer information which is periodically transferred to the provider processing system.

30. The system of claim 25 wherein the computer processor sends the customer information to the provider processing system when it receives it.

31. The system of claim 25 wherein the provider processing system sends correspondence for the customer to the computer processor and the correspondence is branded with the merchant's brand before being sent to the customer.

32. The system of claim 25 wherein the customer information does not include financial information.

33. The system of claim 25 wherein the subscription-based product has an SKU which is used by the merchant to sell the subscription-based product to the customer.

34. The system of claim 25 wherein the computer processor sends the status of the customer's account to the provider.

35. A method for dynamically generating a product offer by a provider, comprising the steps of:
creating a dynamic offer for a customer on a computer processor based upon a predetermined set of factors;
offering the dynamic offer to the customer;
analyzing the success of the dynamic offer offered to the customer on a computer processor;
using the success of the dynamic offer as a factor in creating a subsequent dynamic offer;
wherein the predetermined set of factors comprises the customer's geo-location, the customer's shopping behavior, the customer's credit information, and wherein the product offer is a dynamically priced product or service or a dynamically bundled plurality of products or services.

36. The method of claim 35 further comprising the step of receiving customer demographics and preferences from the customer when he or she registers with the provider, wherein the predetermined set of factors includes the preferences.

37. The method of claim 35 wherein the step of creating occurs after the customer has initiated a purchase from a merchant.

38. The method of claim 37 wherein the predetermined set of factors includes information about the purchase.

39. The method of claim 35 wherein the provider and the merchant are the same entity.

40. The method of claim 35 wherein the predetermined set of factors includes information about the customer obtained by searching database records not under the control of the provider.

41. The method of claim 40 wherein the database records are public records or social network records.

42. The method of claim 35 wherein the step of creating occurs based upon the customer's proximity to a predetermined location.
